(19) United States
(12) Patent Application Publication
(10) Pub. No.: US 2007/0103407 A1
(43) Pub. Date: May 10, 2007

(54) DISPLAY DEVICE

(75) Inventors: Byung-sik Koh, Gwangmyeong-si (KR); Nam-deog KIM, Yongin-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/552,272

(22) Filed: Oct. 24, 2006

(30) Foreign Application Priority Data
Oct. 24, 2005 (KR) 2005-0100397

(51) Int. Cl. G09G 3/30

(52) U.S. Cl. 345/76

(57) ABSTRACT

A display device includes a case in which a storage space is formed and an organic light emitting diode (“OLED”) panel inserted into the storage space. The case includes a front face and a rear face, whereby one of the front and the rear face includes an opening defining a display region and a slit for communicating the storage space and an outside of the case formed at one side of the case.

This application claims priority to Korean Patent Application No. 2005-0100397, filed on Oct. 24, 2005 and all the benefits accruing therefrom under 35 U.S.C. §119, the contents of which is incorporated herein by reference in its entirety.

### BACKGROUND OF INVENTION

1. Field of Invention

The present invention relates to a display device, and more particularly, to a display device in which an organic light emitting diode panel is slidably inserted into a case.

2. Description of the Related Art

Among flat panel displays, an organic light emitting diode (“OLED”) device has been highlighted due to advantages in terms of low voltage driving, light weight, a thin profile or type, a wide viewing angle, high speed response and the like.

Since an OLED panel forming images in the OLED device is only about 1 millimeter (mm) to 1.5 millimeters (mm) in thickness, a structure for supporting the OLED panel is required. Conventionally, a top chassis and a bottom chassis are used as such a structure. The OLED panel is housed between the top chassis and the bottom chassis, and the chassis are fixed to each other using a screw or the like.

However, such a conventional supporting method has a disadvantage in that a display device becomes very thick in thickness and heavy in weight due to use of the chassis and the assembling of the top and the bottom chassis is complicated.

### BRIEF SUMMARY OF THE INVENTION

An exemplary embodiment provides a display device wherein its thickness is thin, and its assembling is simple.

An exemplary embodiment provides a display device including a case in which a storage space is formed and an organic light emitting diode (“OLED”) panel inserted into the storage space. The case includes a front and a rear face, whereby one of front and rear face includes an opening defining a display region. and a slit for communicating the storage space and an outside of the OLED panel formed at one side of the case. The slit accommodates the OLED panel during insertion into the case.

In an exemplary embodiment, the display device further includes a driving part connected to the OLED panel and at least a part of the driving part is exposed out of the case through the slit.

In an exemplary embodiment, the case includes a stopper fixing the OLED panel such that movement of the inserted OLED panel is restricted in a reverse direction to an insertion direction.

In an exemplary embodiment, the stopper is contacted with a side face of the OLED panel adjacent to the slit.

In an exemplary embodiment, the stopper includes a stopping protrusion protruded toward the storage space from the rear face of the case.

In an exemplary embodiment, the stopper pressurizes the OLED panel in a direction perpendicular to the OLED panel.

In an exemplary embodiment, the stopper includes a projection protruded towards the storage space from the front face of the case.

In an exemplary embodiment, the case further includes a guide part for guiding opposite sides of the OLED panel parallel with an insertion direction when the OLED panel is inserted.

In an exemplary embodiment, the front or the rear face other than where the display region is formed includes a shielding region for shielding the OLED panel.

In an exemplary embodiment, through-holes are formed on the shielding region.

In an exemplary embodiment, the display region is formed on both the front and rear faces.

In an exemplary embodiment, the case is formed in a single body.

In an exemplary embodiment, the case is made of a plastic material.

In an exemplary embodiment a display device includes a case, an organic light emitting diode (“OLED”) panel and a stopper. The case includes a storage space therein, a front surface, a rear surface, a first side, a second side opposite to the first side and an opening disposed in the first side. The OLED panel is accommodated by the opening in a direction of insertion and disposed in the storage space. The stopper contacts a face of the OLED panel and restricts movement of the OLED panel in a direction opposing the direction of insertion. The front surface includes a first opening part forming a display region and covers peripheral. edges of the OLED panel.

### BRIEF DESCRIPTION OF THE DRAWINGS

The above and/or other aspects and advantages of the prevent invention will become apparent and more readily appreciated from the following description of the exemplary embodiments, taken in conjunction with the accompany drawings, in which:

FIG. 1 is a perspective view of an exemplary embodiment of a display device according to the present invention;

FIGS. 2A and 2B are exploded and enlarged perspective views of the display device in FIG. 1;

FIG. 3 is a cross-sectional view taken along line III-III in FIG. 1;

FIG. 4 is a cross-sectional view taken along line IV-IV in FIG. 1;

FIG. 5 is a cross-sectional view taken along line V-V in FIG. 2A;

FIG. 6 is a cross-sectional view of another exemplary embodiment of a display device according to the present invention;

FIG. 7 is a cross-sectional view of another exemplary embodiment of a display device according to the present invention;

FIG. 8 is a perspective view of another exemplary embodiment of a display device according to the present invention;

FIG. 9 is a perspective view of another exemplary embodiment of a display device according to present invention; and

FIG. 10 is a perspective view showing an exemplary embodiment of a finished display set using a display device according to the present invention.

### DETAILED DESCRIPTION OF THE INVENTION

Reference will now be made in detail to the embodiments of the present invention, examples of which are illustrated in the accompanying drawings, wherein like reference numerals refer to like elements throughout, and descriptions for the like reference numerals may be omitted in other embodiments except a representative first embodiment. The embodiments are described below so as to explain the present invention by referring to the figures.

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

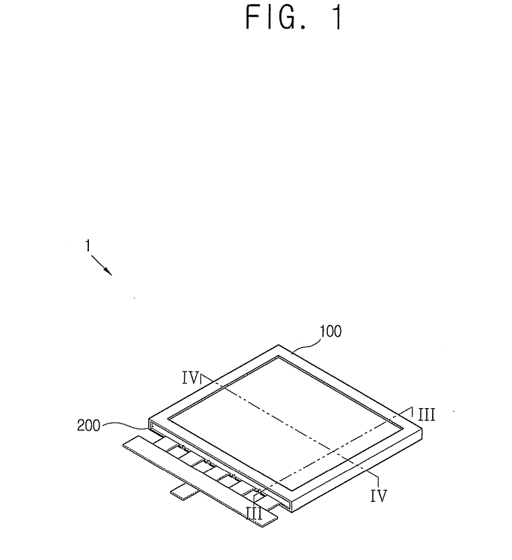

An exemplary embodiment of a display device according to the present invention will be described below with reference to FIGS. 1 to 5.

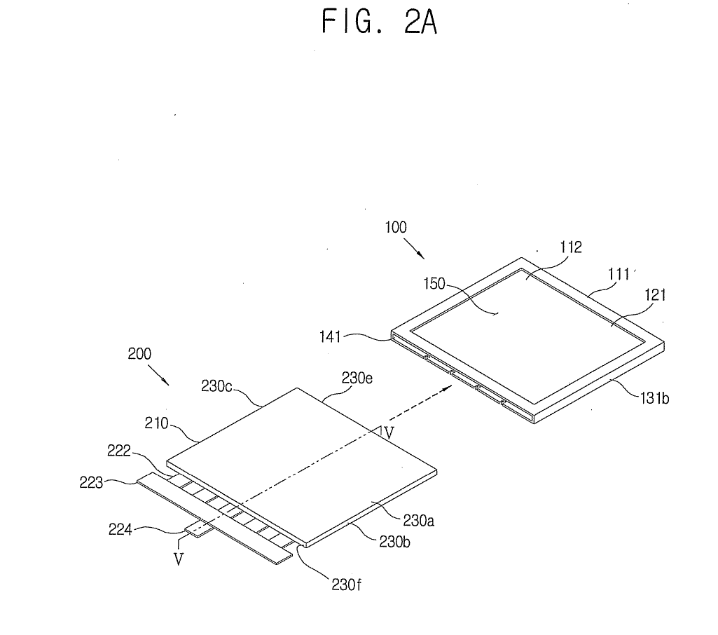

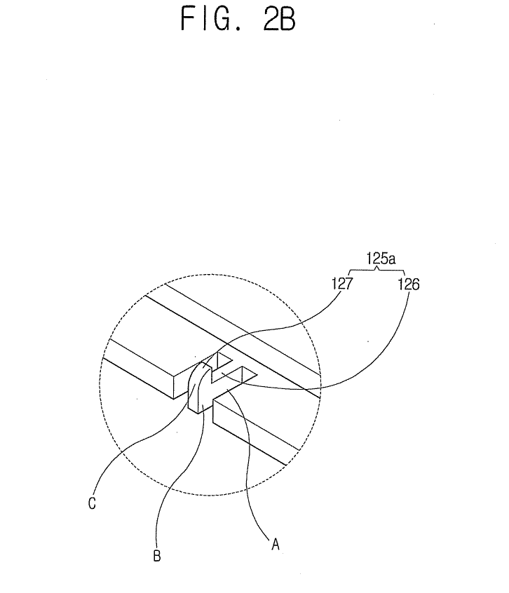

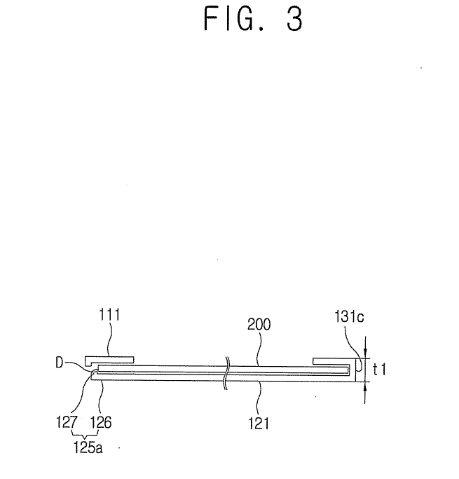

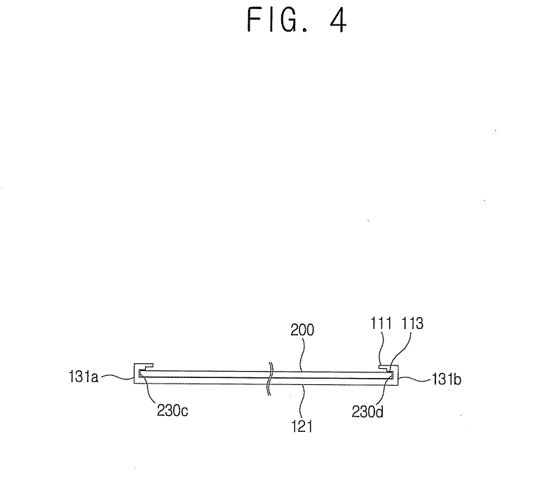

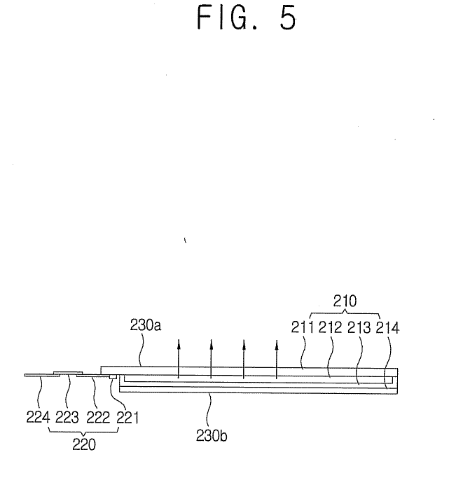

FIG. 1 is a perspective view of an exemplary embodiment of a display device according to the present invention, FIGS. 2A and 2B are exploded and enlarged perspective views of the display device in FIG. 1, FIG. 3 is a cross-sectional view taken along line III-III in FIG. 1, FIG. 4 is a cross-sectional view taken along line IV-IV in FIG. 1, and FIG. 5 is a cross-sectional view taken along line V-V in FIG. 2A.

Referring to FIG. 1, a display device 1 includes a case 100 shaped substantially like a rectangular plate and a display assembly 200, such as an OLED assembly received inside the case 100. Here, a portion of the OLED assembly 200 is exposed out of the case 100.

The case 100 forms a storage space 150 having a display panel 210, such as an OLED panel, inserted therein. The storage space 150 has a shape substantially corresponding in shape and dimension to the OLED panel 210. In exemplary embodiments, the case 100 may be made in a single body and/or the material thereof may be plastic.

The case 100 includes a substantially plate-shaped rear face 121, first, second and third side faces 131a, 131b and 131c, respectively, vertically extended from the rear face 121, and a front face 111 horizontally extended from each of the side faces 131a, 131b and 131c and substantially parallel with the rear face 121.

A center portion of the front face 111 is removed so that an opening part 112 defining a display region is formed. The rear face 121 effectively forms a shielding region for shielding the OLED panel 210. At one side of the case 100 is formed a slit 141 for inserting the OLED assembly 200. The slit 141 is dimensioned and structured to accommodate the OLED panel 210 during insertion.

Referring to FIG. 5, the OLED assembly 200 includes the OLED panel 210 and a driving part 220 connected to one side of the OLED panel 210. The driving part 220 receives a signal from an external circuit (not shown) and then drives the OLED panel 210. A portion of the driving part 220 is exposed from the case 100 while being connected to the OELD panel 210.

The OLED panel 210 includes an insulation substrate 211, a light emitting part 212 formed on the insulation substrate 211, a passivation layer 213 covering the light emitting part 212 and a protection substrate 214 attached on an upper surface of the passivation layer 213. In exemplary embodiments, the light emitting part 212 generates light using the combination of electrons and holes and may include a low molecular polymer material. The passivation layer 213 and the protection substrate 214 reduce or effectively prevent an external impact from being transmitted to the light emitting part 212 and protect the light emitting part 212 from moisture and air.

In the illustrated embodiment of FIGS. 1-5, the OLED panel 210 is of a bottom emission type in which light generated from the light emitting part 212 is emitted toward a surface of the insulation substrate 211.

The OLED panel 210 includes a first surface 230a from which light is emitted to the outside, a second surface 230b facing the first surface 230a, a third surface 230c and a fourth surface 230d substantially parallel with a insertion direction of the OLED panel 210 while facing to each other, a fifth surface 230e located at the front of the insertion direction and a sixth surface 230f adjacent to the driving part 220 while opposing (and facing) the fifth surface 230e.

The driving part 220 includes a driving chip 221 mounted on the insulation substrate 211, a connecting FPC (flexible printed circuit) 222 connected to the driving chip 221, a driving FPC 223 connected to the driving chip 221 via the connecting FPC 222 and an external connecting part 224 connected to the external circuit for transmitting a signal to the driving FPC 223. In exemplary embodiments, the connecting FPC 222 may be bent to extend toward the rear face 121 of the case 100.

In one exemplary embodiment, the driving chip 221 may be formed through a Chip On Glass (“COG”) method. In the illustrated exemplary embodiments, may include the driving chip 221 mounted on the OLED panel 210 through the Chip On Film (“COF”) method or any other method suitable for the purpose described herein.

The OLED assembly 200 is arranged such that the first surface 230a emitting light therefrom faces the opening part 112 formed on the front face 111 of the case 100 when the OLED assembly 200 is inserted in the storage space 150 while sliding.

In an exemplary embodiment of a method of insertion of the OLED assembly 200 into the case 100, the third and the fourth surfaces 230c and 230d of the OLED panel 210 become parallel with the insertion direction. Referring to FIGS. 3 and 4, in a state of insertion, a portion of the (peripheral) edge of the first surface 230a of the OLED panel 210 is covered with the front face 111 of the case 100.

The case 100 has a guide part 113 for stably executing the insertion of the OLED panel 210 and a stopper 125a for preventing the inserted OLED panel 210 from being separated from the case 100.

As shown in FIG. 4, the guide part 113 is protruded toward the storage space 150 from the front face 111 adjacent to each of the third and the fourth surfaces 230c and 230d of the OLED panel 210. The guide part 113 minimizes an interval between opposite ends of the OLED panel 210 and the case 100 so that the OLED panel 210 is stably inserted.

The guide part 113 may be effective where the height of the storage space 150 is relatively larger than the thickness of the OLED panel 210. The guide part 113 may not be separately formed in a case where the height of the storage space 150 is similar to the thickness of the OLED panel 210.

As shown in FIG. 2B, the stopper 125a is formed on the rear face 121 of the case 100. In an alternative embodiment, the stopper may be formed on the front face 111. The stopper 125a includes a connecting part 126 extended outward from the rear face 121 and a catching part 127 protruded toward the front face 111 from the connecting part 126. One side A of the connecting part 126 is connected with the rear face 121. Side B of the connecting part 126 is not connected with the rear face 121. Since side A is connected to the rear face and side B is not connected with the rear face, is possible to deform or modify the connecting part 126 to a certain extent.

The catching part 127 is extended from the side B of the connecting part 126 and includes an inclination surface C making an acute angle with the rear face 121. The catching part 127 includes a substantially vertical surface D extended toward the rear face 121 from the top of the inclination surface C.

During insertion of the OLED panel 210 as shown in the direction of the arrow in FIG. 2A, the catching part 127 is modified downward due to the contact with the second surface 230b of the OLED panel 210. When the insertion of the OLED panel 210 is completed as shown in FIGS. 3-5, the sixth surface 230f of the OLED panel 210 passes through the catching part 127 and is then located on the connecting part 126. The modification of the stopper 125a is released and returns to the original state. The vertical surface D of the catching part 127 confronts or corresponds to the sixth surface 230f of the OLED panel 210.

When the OLED panel 210 is ultimately inserted into the case, if the OLED panel 210 proceeds to the reverse direction of the insertion direction, e.g., if it is separated from the case 100, the catching part 127 is contacted with the sixth surface 230f of the OLED panel 210 so that the movement of the OLED panel 210 is restricted.

In alternative exemplary embodiments, the stopper 125a may be formed on the front face 111 and/or the shape of the catching part 127 may be modified in various forms of a hemisphere or the like. In an exemplary embodiment, the stopper 125a may be manufactured separately from the case 100 and then coupled to the case 100.

The illustrated embodiment of the display device has the following advantages.

Assembling of the case 100 and the OLED assembly 200 is simple. That is, the assembling is completed by means of sliding the OLED assembly 200 to be inserted in the case 100. This is a simpler method as compared with a method including coupling a chassis using a screw or the like.

The overall thickness (t1 in FIG. 3) of the display device 1 can be reduced. The OLED assembly 200 of the illustrated embodiment has a further advantage in that there is required no backlight contrary to a liquid crystal display so that the OLED assembly 200 is of a relatively thin type. In a case where the OLED assembly 200 is stored in a chassis, it may be difficult to take full advantage of a thin type OLED assembly 200 so as to guarantee a space for coupling the screw to the chassis. In the illustrated exemplary embodiment, there is required no screw when manufacturing the display device 1 so that the thickness of the display device 1 can be minimized.

The case 100 may be simply manufactured, such as through plastic molding, so that manufacturing costs can be reduced. Further, the weight of the display device 1 can be reduced as compared with a chassis made of a metallic material.

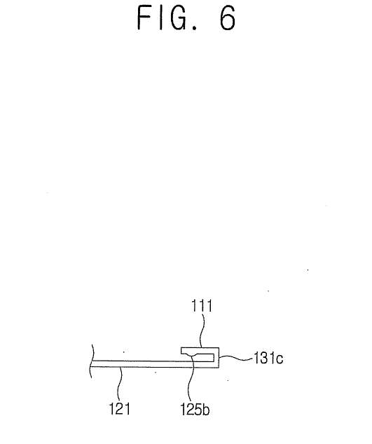

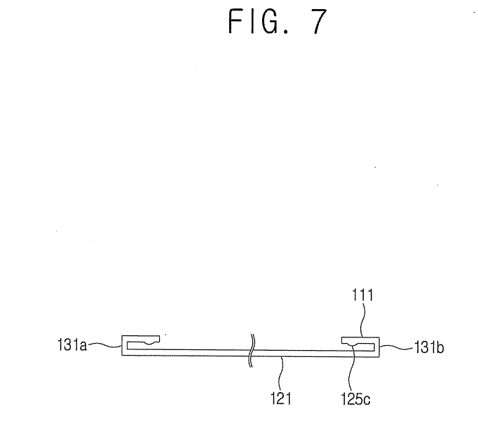

FIGS. 6 and 7 are cross-sectional views of exemplary embodiments of display devices according to the present invention.

In the illustrated embodiment shown in FIG. 6, a stopper 125b is a projection protruded toward a rear face 121 from a front face 111. The stopper 125b may have the shape of a hemisphere or semicylinder. An OLED panel 210 is located between the stopper 125b and the rear face 121 and the stopper 125b effectively “pressurizes” the OLED panel 210 in a direction substantially perpendicular thereto so that the movement of the OLED panel 210 is restricted.

The stopper 125b is located to be adjacent to a side face 131c of a case 100 located at the front of an insertion direction, which is for the purpose that the stopper 125b does not influence on the OLED panel 210 in an intermediate process of insertion thereof. That is, the stopper 125b essentially operates when the insertion of the OLED panel 210 is completed.

In the illustrated embodiment shown in FIG. 7, a stopper 125c is a projection protruded toward a rear face 121 from a front face 111. The stopper 125c may have the shape of a hemisphere or semicylinder. The stopper 125c is located to be adjacent to each of the opposite side faces 131a and 131b of a case 100, which are opposing to each other.

In an exemplary embodiment, the stopper 125c is formed to be relatively close to a side face 131c of the case 100, which is for the purpose that the stopper 125c does not influence on the OLED panel 210 in insertion process thereof. The stopper 125c proximate the side faces 131a and 131b may be at a similar distance from the side faces or one stopper 125c may be closer to its respective side face than the other stopper 125c.

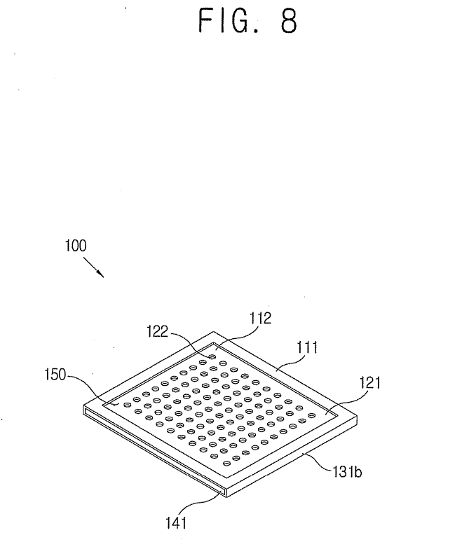

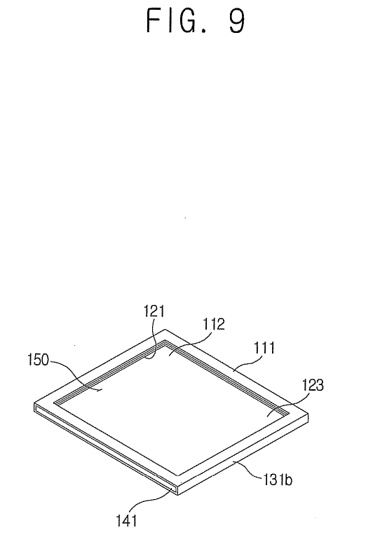

FIGS. 8 and 9 are perspective views of additional exemplary embodiments of display devices according to the present invention, respectively.

According to the illustrated embodiment shown in FIG. 8, the front face 111 of the case includes the opening part 112 forming the display region. A plurality of through-holes 122 are formed on a rear face 121 of the case 100. The portion of the rear face 121 where the through-holes are formed, such as an area within inner edges of the front face 111 when viewed on a plane, may be considered the shielding region.

When an OLED panel 210 is driven, heat may be generated. Unless the heat is appropriately radiated, devices including the OLED panel 210 may be degraded so that display quality is deteriorated. The through-holes 122 formed on the rear face 121 allow the heat generated from the OLED panel 210 to be radiated to the outside of the display device through convection. The through-holes may be formed in any of a number of shapes suitable for the purpose described herein, such as substantially rectilinear, circular, semi-circular and the like.

According to the illustrated embodiment shown in FIG. 9, a portion of the rear face 121 of the case 100 is partly removed so that an opening part 123 is formed and the opening part 123 forms another display region. The display regions are formed on the front and the rear surfaces 111 and 121 of the case 100. In an exemplary embodiment, the display region may be formed on an entirety of the front and the rear surfaces 111 and 121.

Light emitted from a light emitting part 212 of an OLED panel 210 progresses in all directions. In exemplary embodiments, where components located on the upper and the lower portions of the light emitting part 212 are transparent, it is possible to implement screens on both faces of the OLED panel 210.

A display device 1 as in the illustrated exemplary embodiments may be used for portable electronic devices such as a mobile phone, monitors of computers, televisions and the likes, and a form of a finished display set and a signal input to the display device 1 are variously modified depending on use.

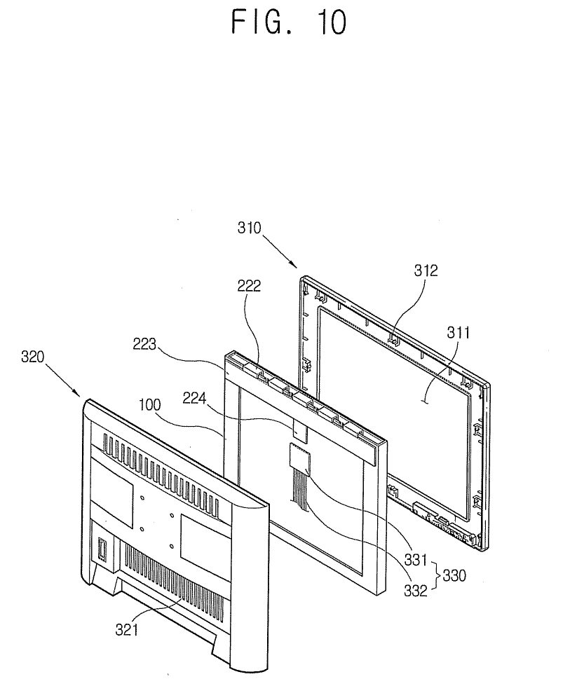

FIG. 10 is a perspective view showing an exemplary embodiment of a finished display set using a display device according to the present invention.

The display device 1 is housed between a front cover 310 and a rear cover 320.

An opening part 311 is formed on the front cover 310 such that the display region of the display device 1 is exposed, and a coupling projection 312 of the front cover 310 is formed on a portion of the front cover 310 facing the rear cover 320.

Through-holes 321 for eliminating heat generated from the display device 1 are formed on the rear cover 320 and a coupling groove (not shown) corresponding to the coupling projection 312 of the front cover 310 is formed thereon. The front cover 310 and the rear cover 320 are joined with each other by the coupling projection 312 and the coupling groove.

An external connecting part 224 extended to the rear of the display device 1 is connected to an external source (not shown) via a connecting part 330. The connecting part 330 includes a connecting jack 331 connected to a connecting cable 332. The display device is coupled with a connecting jack 331 connected to a connecting cable 332 so as to receive a signal from the external source. In one exemplary embodiment, the connecting cable 332 may be connected to a computer main body.

As in the illustrated exemplary embodiments, there is provided a display device wherein its thickness is thin and its assembling is simple.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display device comprising:
a case in which a storage space is formed, and
an organic light emitting diode panel inserted in the storage space,
wherein the case includes:
a front and a rear face, wherein one of the front and the rear face includes an opening defining a display region, and
a slit for communicating the storage space and an outside of the case formed at one side of the case, wherein the slit accommodates the organic light emitting diode panel during insertion.

2. The display device according to claim 1, further comprising a driving part connected to the organic light emitting diode panel, wherein a part of the driving part is exposed out of the case through the slit.

3. The display device according to claim 1, wherein the case comprises a stopper fixing the organic light emitting diode panel such that movement of the inserted organic light emitting diode panel is restricted in a reverse direction to an insertion direction.

4. The display device according to claim 3, wherein the stopper is contacted with a side face of the organic light emitting diode panel adjacent to the slit.

5. The display device according to claim 4, wherein the stopper comprises a stopping protrusion protruded toward the storage space from the rear face.

6. The display device according to claim 3, wherein the stopper pressurizes the organic light emitting diode panel in a direction perpendicular to the organic light emitting diode panel.

7. The display device according to claim 6, wherein the stopper comprises a projection protruded towards the storage space from a rear of the front face.

8. The display device according to claim 1, wherein the case further includes a guide part guiding opposite sides of the organic light emitting diode panel parallel with an insertion direction when the organic light emitting diode panel is inserted.

9. The display device according to claim 1, wherein the front or the rear face other than where the display region is formed includes a shielding region for shielding the organic light emitting diode panel.

10. The display device according to claim 9, wherein through-holes are formed on the shielding region.

11. The display device according to claim 1, wherein the display region is formed on both the front and the rear face.

12. The display device according to claim 1, wherein the case is formed in a single body.

13. The display device according to claim 1, wherein the case is made of a plastic material.

14. A display device comprising:
a case including a storage space therein, a front surface, a rear surface, a first side, a second side opposite to the first side and an opening disposed in the first side;
an organic light emitting diode panel accommodated by the opening in a direction of insertion and disposed in the storage space; and
a stopper contacting a face of the organic light emitting diode panel and restricting movement of the organic light emitting diode panel in a direction opposing the direction of insertion;
wherein the front surface includes a first opening part forming a display region and covers peripheral edges of the organic light emitting diode panel.

15. The display device according to claim 14, wherein the stopper is disposed on the rear surface corresponding to the first side, the stopper comprising:
a connecting part extended from the rear surface towards an outside of the case; and
a catching part protruded from the connecting part towards the front surface and contacting a side face of the organic light emitting diode panel.

16. The display device of claim 15, further comprising a plurality of the stopper.

17. The display device according to claim 14, wherein the stopper is disposed on a rear of the front surface corresponding to the second side, the stopper including a projection protruded towards the storage space and contacting an upper face of the organic light emitting diode panel.

18. The display device according to claim 14, wherein the case further comprises a third side and a fourth side opposite to the third side,
wherein the stopper is disposed on a rear of the front surface corresponding to each of the third and the fourth sides and adjacent to the second side, the stopper including a projection protruded towards the storage space and contacting an upper face of the organic light emitting diode panel.

19. The display device according to claim 14, wherein the rear surface includes a second opening part, the display region including the second opening part.

20. The display device according to claim 14, further comprising holes formed in the rear surface and eliminating heat generated by the organic light emitting diode panel.
